(19) United States
(12) Patent Application Publication
(10) Pub. No.: US 2026/0365188 A1
(43) Pub. Date: Nov. 19, 2026

(54) VEHICULAR DRIVING ASSIST SYSTEM WITH ENHANCED IMAGE PROCESSING

(71) Applicant: Magna Electronics Inc., Auburn Hills, MI (US)

(72) Inventor: Gangadhar Reddy Yadiki, Macomb, MI (US)

(21) Appl. No.: 19/679,909

(22) Filed: May 18, 2026

Related U.S. Application Data
(60) Provisional application No. 63/808,090, filed on May 19, 2025.

(51) Int. Cl. B60W 50/029; B60W 30/06; B60W 30/09; B60W 30/12; B60W 30/14; B60W 30/18; B60W 50/00; B60W 50/02; B60W 50/14; G06V 10/82; G06V 10/98; G06V 20/56; G07C 5/08

(52) U.S. Cl. CPC B60W 50/029; B60W 30/06; B60W 30/09; B60W 30/12; B60W 30/14; B60W 30/18163; B60W 50/0097; B60W 50/0205; B60W 50/14; G06V 10/82; G06V 10/993; G06V 20/56; G07C 5/085; B60W 2050/0215; B60W 2420/403

(57) ABSTRACT

A vehicular driving assist system includes a camera and an electronic control unit (ECU) that, responsive to processing image data captured by the camera, scans two or more lines of a frame of image data. The system, via a cryptographic hash function, determines a respective hash value for each scanned line of the two or more scanned lines of the frame. The system, responsive to determining the respective hash value for each scanned line of the two or more scanned lines of the frame, aggregates the respective hash values into a final frame hash value. The system determines that the final frame hash value indicates that at least one line of the two or more scanned lines of the frame are corrupted. The system isolates the frame to prevent the frame from being ingested by a neural network of the vehicle.

### CROSS REFERENCE TO RELATED APPLICATION

The present application claims the filing benefits of U.S. provisional application Ser. No. 63/808,090, filed May 19, 2025, which is hereby incorporated herein by reference in its entirety.

### TECHNICAL FIELD

The present disclosure relates generally to a vehicle vision system for a vehicle and, more particularly, to a vehicle vision system that utilizes one or more cameras at a vehicle.

### BACKGROUND

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY

A vehicular driving assist system includes a camera disposed at a vehicle equipped with the vehicular driving assist system that views exterior of the vehicle. The camera is operable to capture image data. The camera includes an imager. An electronic control unit (ECU) includes electronic circuitry and associated software and the electronic circuitry of the ECU includes an image processor for processing image data captured by the camera. The ECU, responsive to processing by the image processor of one or more frames of image data captured by the camera, scans two or more lines of a frame of image data. The vehicular driving assist system, via a cryptographic hash function, determines a respective hash value for each scanned line of the two or more scanned lines of the frame. The vehicular driving assist system, responsive to determining the respective hash value for each scanned line of the two or more scanned lines of the frame, aggregates the respective hash values for each line of the two or more lines of the frame into a final frame hash value. The vehicular driving assist system, responsive to aggregating the respective hash values for each line of the two or more lines of the frame into the final frame hash value, determines that the final frame hash value indicates that at least one line of the two or more scanned lines of the frame are corrupted. The vehicular driving assist system, responsive to determining that the final frame hash value indicates that at least one line of the two or more scanned lines of the frame are corrupted, isolates the frame to prevent the frame from being ingested by a neural network of the vehicle.

These and other objects, advantages, purposes and features of the present disclosure will become apparent upon review of the following specification in conjunction with the drawings.

### BRIEF DESCRIPTION OF THE DRAWINGS

FIG. 1 is a plan view of a vehicle with a driving assist system that incorporates cameras;

FIG. 2 is a block diagram of a vehicular driving assist system that performs line-level hashing of image data; and

FIG. 3 is a flow chart of a method for line-level hashing of image data.

### DETAILED DESCRIPTION

A vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. For example, the image processor may utilize advanced machine learning architectures, such as convolutional neural networks (CNNs), region-based CNNs (R-CNNs), or vision transformers, to perform semantic segmentation, bounding box generation, and object classification on the received image data. Optionally, the vision system may provide display, such as a rearview display or a top-down or bird's-eye or surround-view display or the like, which may involve the image processor performing real-time image stitching, lens distortion correction, and perspective transformations of image data received from multiple cameras.

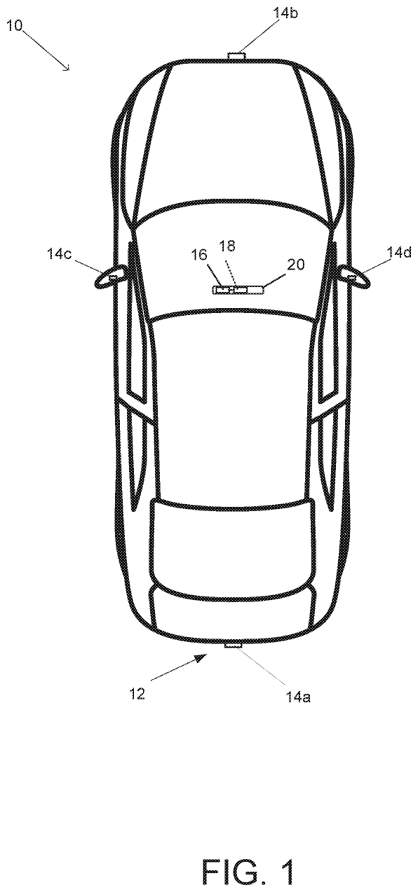

Referring now to the drawings and the illustrative embodiments depicted therein, a vehicle 10 includes an imaging system or driving assist system or vision system 12 that includes at least one exterior-viewing imaging sensor or camera, such as a rear backup camera or rearward-viewing imaging sensor or camera 14a (and the system may optionally include multiple exterior-viewing imaging sensors or cameras, such as a forward-viewing camera 14b at the front (or at the windshield) of the vehicle, and a sideward/rearward-viewing camera 14c, 14d at respective sides of the vehicle), which captures images exterior of the vehicle. The camera has a lens for focusing images at or onto an imaging array or imaging plane or imager of the camera (FIG. 1). By way of example, the imager may comprise a high-dynamic-range (HDR) complementary metal-oxide-semiconductor (CMOS) imaging array having at least one million photosensors arranged in rows and columns, utilizing either a rolling shutter or a global shutter topology. Optionally, a forward-viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software. The electronic circuitry may include a data processor or image processor, as well as hardware accelerators such as graphics processing units (GPUs), tensor cores, and/or neural processing units (NPUs) operable to process image data captured by the camera or cameras, whereby the ECU may detect or determine the presence of objects or the like and/or the system provides displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable high-bandwidth data or communication link, such as a vehicle network bus or the like of the equipped vehicle, which may include Gigabit Multimedia Serial Link (GMSL), Flat Panel Display Link (FPD-Link), Automotive Ethernet, and/or Mobile Industry Processor Interface (MIPI) Camera Serial Interface 2 (CSI-2) protocols.

A vehicular vision system, vehicular driving assist system, vehicular control system, and/or an advanced driver assistance system (ADAS) of a vehicle uses image data (e.g., a continuous video stream of image data) captured by one or more high-resolution imaging sensors (e.g., cameras) to detect objects and/or pedestrians proximate to the vehicle. The system may use the image data to determine information regarding the environment of the vehicle, such as intersections, road signs, lane markers, road boundaries, etc. Based on the detected objects and/or determined information regarding the environment of the vehicle, the system may enable one or more systems and/or features of the vehicle, such as lane-keeping, obstacle avoidance, auto park assistance, blind spot monitoring, adaptive cruise control, lane centering control, lane-change assist, etc. Accordingly, there is a need to efficiently analyze or hash the image data for corruption in order to improve integrity, authenticity, and traceability of frames of the image data to maximize the safe operation of these systems and features. That is, hashing image data may be used to determine whether the image data is corrupted, such as by spoofs, tampering, modifications, and/or injection attacks. Injection attacks, for instance, may include man-in-the-middle (MITM) attacks over the sensor bus where an adversary injects malicious deepfakes, replays old image frames to mask an obstacle, or introduces adversarial pixel perturbations specifically engineered to cause a deep neural network (DNN) of the ADAS to misclassify an object. A vehicular driving assist system may perform secure identification and real-time data integrity verification of the frames of image data captured by the one or more cameras to comply with emerging automotive cybersecurity standards. Optionally, a System-On-Chip (SoC) of the system processes the image data to determine tampering and/or manipulation of frames of image data at the hardware level.

A system may attempt to hash entire frames of image data (e.g., frame-level hashing) by either hashing each frame of a plurality of frames of the image data or a sample of frames of the plurality of frames of image data. However, hashing entire frames of image data results in high latency in the processing of the image data due to the high computational throughput used to hash each frame. Specifically, frame-level hashing typically requires the system to wait for an End of Frame (EOF) signal to buffer the entire frame into external dynamic random-access memory (DRAM) before the cryptographic hash function can begin. Hashing entire frames of image data may utilize high percentages of memory bandwidth and increase the time used to process the image data, which delays the detection of objects and/or determination of information by a system using a linear processing pipeline, such as the vehicular driving assist system. That is, hashing entire frames of data disrupts the paradigm of line-buffer image signal processor (ISP) pipelines, resulting in delayed image processing in a system that natively captures, processes, and makes determinations based on image data in a linear, real-time manner. In sum, a system that hashes entire frames of image data leads to high latency in processing the image data, increased memory usage of the system, cache thrashing, and therefore is incompatible with real-time, line-based image processing pipelines where the processing budget for a 30 frames-per-second stream is often less than 33 milliseconds. The high latency may delay the detection of corrupt frames of image data (e.g., tampering, spoofing, and injection attacks to the system at image sensor inputs), which drastically increases the vulnerability of the system. Delayed detection of corrupt frames of image data or unauthorized camera replacement may limit the effectiveness of real-time systems of the vehicle, potentially resulting in unsafe vehicle behavior, loss of control of the vehicle, and/or vehicular accidents.

A vehicular driving assist system, vehicular vision system, vehicular control system, and/or ADAS may perform line-by-line cryptographic hashing of a frame of image data in early steps of image processing. Hashing the frame of image data at a line-level improves real-time integrity verification of frames of image data, minimizing latency and memory usage. That is, integrating line-by-line cryptographic hashing into early stages of a camera video pipeline may enable real-time integrity verification of camera frames with minimal latency and memory overhead. For example, rather than waiting for an End of Frame (EOF) signal, hashing logic may initiate as soon as a horizontal sync (HSYNC) signal indicates the completion of a single line readout from the image sensor. A frame of image data may be processed as a plurality of lines (e.g., scan lines corresponding to individual physical rows of a CMOS pixel array). The system may hash each line from the frame individually (i.e., line-level hashing) using secure parameters such as line number, timestamp, and camera ID (i.e., an identifier assigned to the camera that captured the image data being hashed). To further protect against replay attacks or sophisticated spoofing, the secure parameters may also optionally include a cryptographically secure pseudo-random number (nonce), a session-specific cryptographic salt, and/or a shared secret key provisioned during vehicle manufacturing. That is, line-level hashing includes determining, via a hash function, whether individual lines of a frame of image data are corrupted before the entire frame is fully written to system memory.

The system aggregates hash values determined for each line of the frame of image data back into a final frame hash (FFH) value. The FFH value may be used by the system to perform verification, determining that all lines associated with the frame are uncorrupted. That is, the system may, upon determining whether the data of each line of a given frame is corrupted, aggregate the hash values associated with each line of the given frame to determine whether the frame includes only uncorrupted lines. The FFH value may be determined using a sequential accumulation and/or a Merkle tree or structure. In a sequential accumulation approach, the system may chain hashes, such as by generating a hash for a current line using the image data of the current line concatenated or XORed with the hash value of the immediately preceding line. Alternatively, when utilizing a Merkle tree structure, individual line hashes act as leaf nodes, and the system hashes pairs of leaf nodes to form intermediate nodes, continuing up the tree until a single root node (the FFH) is formed. This allows the system to not only detect that a frame is corrupted, but to quickly isolate the exact scan line or localized region of the image where the corruption occurred in logarithmic time complexity. The system may use the FFH value to verify the integrity of the image data and/or identify or diagnose anomalies, faults, or tampering with the frame.

The FFH value for each hashed frame of image data may be securely stored, either locally at memory of the vehicular driving assist system or remotely at a database. Local storage may include highly secure, hardware-isolated memory domains, such as a Hardware Security Module (HSM), a Trusted Execution Environment (TEE), or an ARM TrustZone secure enclave to prevent malicious rewriting of the hash logs. Optionally, the hash values associated with each line of a frame may be stored. Additionally or alternatively, the system may transmit the FFH value and/or the line hash values with the video stream of image data such that systems receiving the hash data may trigger immediate fail-safe actions (e.g., internal alerts to one or more systems of the vehicle, alerts to system diagnostics, alerts to a driver of the vehicle, alerts to a manufacturer of the vehicle) responsive to determining that one or more frames of the image data is corrupt (i.e., responsive to determined tampering, corruption, and/or unauthorized camera replacement related to the image data). Such immediate fail-safe actions may include gracefully degrading autonomous driving capabilities (e.g., dropping from SAE Level 4 autonomy to Level 2), shifting confidence intervals in a multi-sensor fusion system to temporarily ignore the compromised camera and rely solely on radar and LiDAR data, or executing an emergency stop maneuver. The modular, line-level hashing process may be implemented in hardware, firmware, and/or hybrid configurations on one or more SoCs associated with the one or more systems of the vehicle (e.g., the vehicular driving assist system, the vehicular vision system, the ADAS, etc.), increasing security and real-time image data integrity for the one or more systems. That is, implementing line-level hashing modularly in hardware, firmware, and/or hybrid configurations on one or more SoCs associated with the one or more systems of the vehicle increases system security by minimizing required transmission of the video stream and/or the hash data across vulnerable intra-vehicle networks.

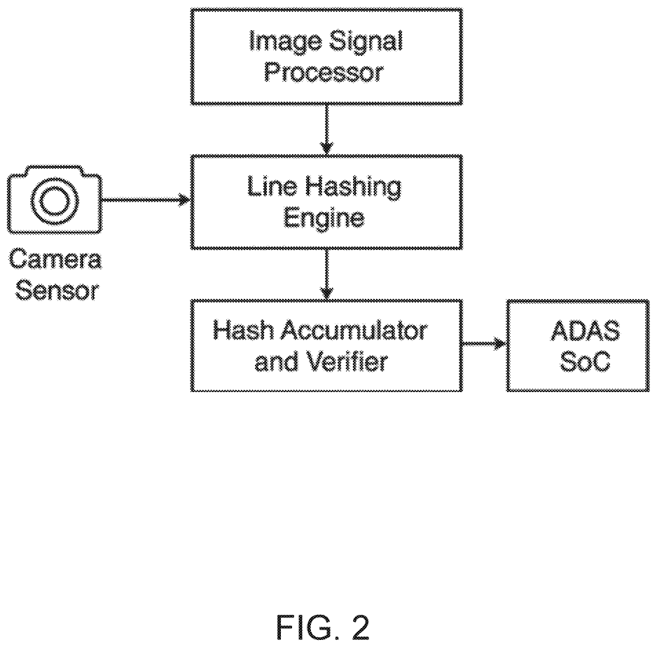

FIG. 2 illustrates an example architecture for line-level frame hashing. The architecture may be implemented at a vehicular system, ADAS, ECU, and/or one or more SoCs. The line-level hashing architecture includes an imaging sensor such as a camera (e.g., an MIPI CSI-2 or LVDS interface) and an image signal processor (ISP) and/or a raw pipeline block. The line-level hashing architecture includes a line hashing engine (LHE) that includes hardware and/or firmware components on an SoC. For example, the LHE may be implemented as a dedicated, hardware-accelerated cryptographic Intellectual Property (IP) core operating in parallel with the ISP via an Advanced extensible Interface (AXI) bus, thereby consuming zero processor clock cycles from the primary vehicle ECU CPU. The LHE may scan a frame of image data from the image sensor into two or more lines and perform a cryptographic hash function on each line to determine a hash value, as discussed further below. The hash value may be used to determine whether the line is corrupted. The line-level hashing architecture includes a hash accumulator and verifier (HAV) that may aggregate the hash values for all lines of a given frame of image data into an FFH value. The FFH value may be used to determine whether one or more lines of the frame are corrupted. The line-level hashing architecture includes a secure hash storage and/or transmission interface. Line hash values and/or FFH values may be stored via the hash storage interface for diagnostic analysis. Additionally or alternatively, the line-level hashing architecture may transmit the line hash values and/or FFH values with their respective frames of image data to a system of the vehicle that receives the image data as input, such as transmitting the cryptographic data within the embedded data lines or blanking intervals of a MIPI CSI-2 transmission payload.

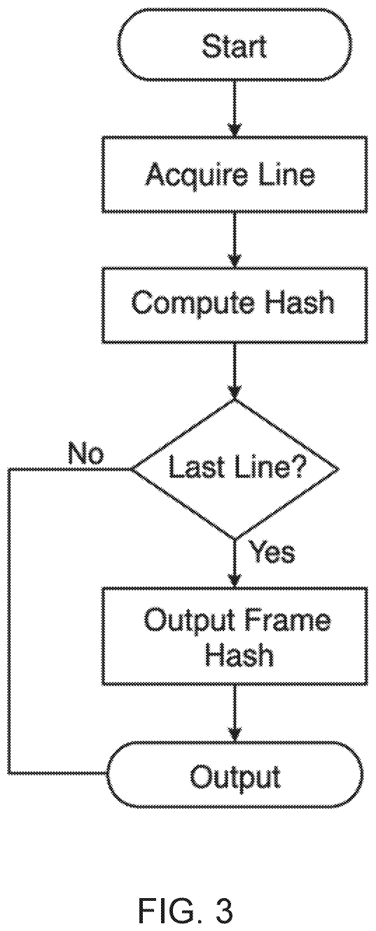

FIG. 3 illustrates exemplary steps of a method for line-level hashing (e.g., for a system that includes the line-level hashing architecture). The method is performed for each frame of a plurality of frames of image data, such as for a continuous video stream operating at 30, 60, or 120 frames per second. The steps may include line acquisition (i.e., scanning two or more lines of a frame of image data), line-level hash computation, line hash aggregation into an FFH, and determining whether the FFH indicates that one or more of the lines of the frame is corrupt. These steps may be tightly pipelined; for example, the system may concurrently perform line acquisition for line n+1 into a buffer while simultaneously executing the line-level hash computation for line n, ensuring zero-wait-state processing that keeps pace with the native pixel clock of the image sensor.

Line acquisition includes scanning a line of two or more lines from a frame of image data captured by the imaging sensor. For example, the system may scan lines (i.e., rows) from the image data in a streaming fashion, such as via direct memory access (DMA) from the imaging sensor to memory of the system. To optimize memory bandwidth, this DMA transfer may utilize scatter-gather techniques or localized static random-access memory (SRAM) ring buffers, storing only the minimal number of lines required for hashing and image processing without requiring a full-frame dynamic random-access memory (DRAM) buffer. Optionally, each line may be processed, in which the system may perform demosaicing, noise reduction, and/or color correction. Demosaicing may involve converting raw Bayer pattern data into an RGB or YUV color space, while noise reduction may employ spatial or temporal filtering algorithms. Furthermore, color correction may include applying white balance adjustments and color matrix transformations to ensure the image data is appropriately calibrated for subsequent deep neural network (DNN) machine vision analysis.

The system may hash each line of the frame to determine whether the line is corrupted (e.g., by spoofs, tampering, modifications, and/or injection attacks). In some examples, hashing may occur on raw Bayer data for sensor integrity. Hashing raw Bayer data directly at the sensor output provides a cryptographic guarantee of the physical sensor bus integrity, mitigating man-in-the-middle (MITM) attacks injected over the wiring harness. In other examples, hashing may occur after ISP for processed output tracking.

Performing the hash after the ISP ensures that the internal memory buses and processing logic of the System-on-Chip (SoC) have not been compromised or subjected to hardware fault injection. During hashing computation, each line Ln is processed by a cryptographic hash function represented by Equation (1), below.

Hₙ=Hash(Ln∥n∥T∥Camera ID) (1)

Here, Hₙ represents a hash of line n (i.e., a hash value for line n), n represents a line number associated with the line of the frame (i.e., a row index), T represents a timestamp associated with the frame of the respective line (i.e., a frame ID), and Camera ID represents a unique identifier for a camera of the one or more cameras of the vehicle that captured the frame. The concatenation symbol “∥” represents a bitwise or byte-wise concatenation of the data elements prior to hashing. Including the line number n cryptographically binds the spatial position of the line, preventing an attacker from executing a line-reordering or line-duplication attack. Including the timestamp T or frame ID acts as a cryptographic nonce to prevent replay attacks where an adversary injects previously recorded, validly hashed lines to mask a current physical obstacle. The Camera ID prevents sensor-swapping attacks where an unauthorized, malicious, or uncalibrated camera is substituted into the vehicle network. The hash function may be SHA-256, BLAKE2s, AES, or a lightweight variant optimized for embedded use. For instance, AES may be implemented as AES-GMAC or AES-CMAC to generate a Message Authentication Code (MAC) utilizing securely provisioned symmetric keys. Lightweight variants may include ASCON or SipHash, which require a significantly lower gate count in hardware ASIC design and consume less dynamic power, making them ideal for high-framerate automotive edge devices operating under strict thermal constraints. The system may repeatedly perform the hash computation for a predetermined portion (e.g., half of the frame) of the frame or each line of the frame. When the system hashes the last line of the frame (or the last line in the predetermined portion), the system may aggregate the hash values for all lines of the frame into an FFH.

The system may perform frame hash aggregation, where a running hash is maintained to combine the hash values Hₙ for all lines Lₙ of the frame into a final frame hash (FFH) value, represented by Equation (2), below.

FFH=Hash(H₁∥H₂∥. . . ∥Hₙ) (2)

In a hardware-accelerated pipeline, maintaining a running hash allows the ECU to update a continuous hash state register incrementally as each intermediate hash value Hₙ is computed, avoiding the need to buffer all intermediate line hashes H1 through Hₙ simultaneously. The system may determine whether the FFH value indicates that one or more lines of the frame are corrupt. In some examples, the system may use a Merkle tree approach to aggregate the hash values Hₙ of the lines Ln of image data for improved verification and partial rechecking. For example, the system may store leaf nodes as individual line hashes and compute intermediate nodes upward, where the root of the tree is the frame hash. This Merkle tree structure provides logarithmic O(log N) verification complexity. If the FFH (the root node) fails verification, the system can quickly traverse down the tree to isolate the exact corrupted line or lines without needing to re-verify the entire frame. This highly granular fault isolation is critical for functional safety (ASIL) diagnostics. Optionally, a k-ary Merkle tree or Tree of Hash Chains may be used in order to balance speed of computation (i.e., speed of processing), real-time verification, and tamper traceability. A Tree of Hash Chains is particularly advantageous for streaming video protocols where the total number of lines in a frame may be dynamic or where buffering must be kept to an absolute minimum, as it allows sequential verification of data blocks precisely as they arrive over the bus.

In some examples, the FFH and/or the one or more hash values Hₙ associated with lines Ln may be stored in secure memory (e.g., a TrustZone or a secure enclave).

This secure memory may be cryptographically isolated from the primary operating system using hardware-enforced access controls, preventing malicious software from altering or deleting the stored hash logs. The memory may be local to the system or a remote database associated with the system. In other examples, the FFH value and/or the one or more individual hashed lines may be embedded in metadata and transmitted with the associated image data (e.g., the video stream) to a system of the vehicle, such as an ADAS, vehicular control system, lane-keep system, obstacle avoidance system, auto park assistance system, blind spot monitoring system, adaptive cruise control system, lane-centering control system, lane-change assist system, etc., thereby providing end-to-end data provenance across the vehicle network. Optionally, the FFH value and/or the one or more individual hash values Hₙ may be transmitted via MIPI CSI-2. Specifically, the system may insert the hash data into the MIPI CSI-2 protocol payload using an Embedded Data Line (EDL), User Defined Data Types (UDT), or within the vertical blanking (VBLANK) metadata, ensuring the security payload remains tightly synchronized with its corresponding visual payload without disrupting standard video decoders. In further examples, the FFH and/or the one or more individual hash values Hₙ may be used as part of an authentication protocol for the vehicular driving assist system and/or other systems or features of the vehicle with and without deep neural network (DNN) models. For example, the vehicular driving assist system may transmit line hash values and/or FFH values with their respective frames of image data to systems of the vehicle that receive the image data as input, such as an ADAS, where the ADAS uses the hash values and/or the FFH values to authenticate the image data that it receives as input. That is, in some examples, the system that receives the frames of image data and associated hash values and/or the FFH values determines whether the hash value and/or FFH value indicates that the frame of image data is corrupted. By gating the input to a DNN using this authentication protocol, the ADAS actively prevents the ingestion of adversarial examples—maliciously crafted pixel perturbations specifically engineered to force a machine learning model to misclassify objects, drop bounding boxes, or hallucinate non-existent obstacles. If the hash verification fails, the system immediately drops the corrupted frame before it reaches the DNN inference engine, thus protecting the vehicle's automated decision-making logic from exploitation and ensuring compliance with stringent automotive cybersecurity frameworks such as ISO/SAE 21434.

A system (e.g., a vehicular driving assist system, vehicular vision system, vehicular control system, ADAS system, etc.) that performs line-level hashing of frames of image data may reduce system latency, as line-level hashing allows the system to start hashing computations early in image processing. By initiating the hash function immediately upon the reception of the first line of pixels, the system eliminates the temporal delay associated with waiting for the vertical blanking (VBLANK) interval that signals the end of a frame. The system may perform real-time image integrity verification, reducing computation time to detect corrupted lines. For example, the system may detect corrupted lines of a frame of image data immediately. This deterministic, sub-millisecond detection capability is critical at highway speeds, where even a single frame of delayed processing translates to significant distance traveled by the vehicle. Line-level hashing increases resistance to corruption, as even a single line of corrupted data may be detected. Line-level hashing improves efficiency of memory usage for the system by eliminating the need to store full frame buffers for hash computation. Consequently, the system significantly reduces the required size of internal Static Random-Access Memory (SRAM) and memory bus bandwidth constraints. Line-level hashing is modular and may be implemented in hardware, firmware, and/or hybrid configurations on one or more SoCs associated with the one or more systems of the vehicle. For instance, a hybrid configuration may utilize a dedicated cryptographic hardware macro for high-speed line hashing while delegating the final frame hash (FFH) tree aggregation to an embedded microcontroller executing secure firmware. The system may protect against and reduce corruption, including spoofs, tampering, modifications, and/or injection attacks to the system at image sensor inputs. Such attacks may include physical hardware tampering, such as an adversary splicing a rogue device into the Gigabit Multimedia Serial Link (GMSL) or FPD-Link wire harness to inject maliciously crafted video overlays.

Line-level hashing may be used for ADAS camera stream verification, autonomous driving data pipelines, vehicular vision system sensor integrity diagnostics, and/or automotive cybersecurity frameworks (e.g., UNECE WP.29, ISO/SAE 21434). These frameworks mandate systematic security risk assessments and the implementation of mechanisms to ensure the authenticity and integrity of sensor data traversing the internal networks of the vehicle. Line-level hashing may be implemented at a hardware IP block in an ADAS SoC (e.g., a TDA4, an NVIDIA Orin, etc.), utilizing dedicated cryptographic engines such as an Evita Full or Medium Hardware Security Module (HSM) to achieve Automotive Safety Integrity Level (ASIL) compliance (e.g., ASIL-B to ASIL-D). Further implementations may include a firmware module of an imaging sensor or a microcontroller within the imaging sensor (e.g., a firmware module in a camera or a microcontroller within the camera), and/or a Linux/QNX driver extension to plug into V4L2 and/or MIPI subsystems. Within a Video4Linux2 (V4L2) subsystem, the driver extension may be configured to append the generated line hashes and the FFH as custom metadata payloads within the V4L2 buffer structures. Similarly, in an AUTOSAR (Automotive Open System Architecture) environment, the hashing architecture can be integrated into the Sensor-Actuator software components to provide secure, end-to-end communication over an Automotive Ethernet backbone.

The system may use line-level hashing to enable hash computation at early stages of image data processing. The system may perform real-time integrity verification with less latency than frame-level hashing. The system may detect corrupt image data and/or integrity-verification failures quickly and perform corrective actions (e.g., perform fail-safe measures) responsive to tampering, frame corruption, and/or unauthorized replacement of a camera of the system and/or the vehicle. These fail-safe measures may encompass executing a transition to a safe state, such as suppressing an automated steering actuation that was based on the corrupted frame, to prevent dangerous system reactions like phantom braking or unintended lane departures. Furthermore, the system may employ sensor fusion algorithms to dynamically de-weight or completely exclude the compromised camera stream, relying instead on secondary modalities such as radar, LiDAR, or ultrasonic sensors. Line-level hashing may be performed without storing full frame buffers to perform the hash computation. Line-level hashing may be implemented at a camera level and/or a system level. Line-level hashing may be implemented in hardware and/or firmware in combination with application-specific integrated circuits (ASICs), SoCs, and/or FPGA main processors. In FPGA implementations, the logic for the line hashing engine and hash accumulator can be synthesized into Register-Transfer Level (RTL) code and instantiated as highly parallelized state machines, ensuring the hash generation strictly keeps pace with the pixel clock of the incoming video stream without dropping frames.

Line-level hashing detects and prevents image data corruption, including spoofs, tampering, modifications, and/or injection attacks to the system at image sensor inputs.

Thus, the system may determine corrupt frames of image data and isolate the corrupt frames of image data to prevent system inputs that may cause unsafe vehicle behavior, loss of control of the vehicle, and/or vehicular accidents. Isolating the corrupt frames may involve dropping the frame pointer at the direct memory access (DMA) controller before the frame can be ingested by the neural network inference engine of the ADAS, effectively neutralizing adversarial pixel attacks. The system may alert a driver of the vehicle visually (e.g., at the infotainment system, dashboard, gauge cluster, etc.), audibly, and/or haptically of determined corruption of and/or tampering with image data from one or more cameras of the vehicle. For instance, a haptic alert may comprise inducing a specific vibration pattern in the steering wheel or driver's seat, while a visual alert may illuminate a dedicated telltale icon on the instrument cluster indicating sensor degradation or security compromise. The system may, upon determining corrupt frames of image data, store the image data and/or integrity failure information (e.g., hash values Hₙ and/or FFH values).

For example, the system may store hash values indicating corrupt image data or integrity failures as diagnostic messages (i.e., diagnostic data, trouble codes, fault codes, etc.) for analysis by a manufacturer of the vehicle and/or for warranty purposes. These diagnostic messages may be formatted as Unified Diagnostic Services (UDS) over Controller Area Network (CAN) or Ethernet faults (e.g., Diagnostic Trouble Codes or DTCs) stored in non-volatile memory (NVM). This secure logging creates an immutable audit trail for forensic analysis following a cybersecurity incident or collision. Optionally, the system may disable the camera associated with the corrupt frames of image data. Disabling the camera may involve severing power to the sensor via a smart field-effect transistor (FET), ignoring its virtual channel ID on the MIPI CSI-2 bus, or mathematically zeroing out its input tensors within the ADAS processing pipeline until an authorized service technician can cryptographically re-authenticate the hardware.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two-dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Optionally, the camera may comprise a forward-viewing camera, such as disposed at a windshield electronics module (WEM) or the like. The forward-viewing camera may utilize aspects of the systems described in U.S. Pat. Nos. 12,174,448; 11,635,672; 11,124, 130; 9,896,039; 9,871,971; 9,596,387; 9,487,159; 8,256,821; 7,480,149; 6,824,281 and/or 6,690,268, which are all hereby incorporated herein by reference in their entireties.

Changes and modifications in the specifically described embodiments can be carried out without departing from the principles of the disclosure, which is intended to be limited only by the scope of the appended claims, as interpreted according to the principles of patent law including the doctrine of equivalents.

1. A vehicular driving assist system, the vehicular driving assist system comprising:
a camera disposed at a vehicle equipped with the vehicular driving assist system and viewing exterior of the vehicle, the camera operable to capture image data;
wherein the camera comprises an imager;
an electronic control unit (ECU) comprising electronic circuitry and associated software;
wherein the electronic circuitry of the ECU comprises an image processor for processing image data captured by the camera;
wherein the ECU, responsive to processing by the image processor of one or more frames of image data captured by the camera, scans two or more lines of a frame of image data;
wherein the vehicular driving assist system, via a cryptographic hash function, determines a respective hash value for each scanned line of the two or more scanned lines of the frame;
wherein the vehicular driving assist system, responsive to determining the respective hash value for each scanned line of the two or more scanned lines of the frame, aggregates the respective hash values for each line of the two or more lines of the frame into a final frame hash value;
wherein the vehicular driving assist system, responsive to aggregating the respective hash values for each line of the two or more lines of the frame into the final frame hash value, determines that the final frame hash value indicates that at least one line of the two or more scanned lines of the frame are corrupted; and
wherein the vehicular driving assist system, responsive to determining that the final frame hash value indicates that at least one line of the two or more scanned lines of the frame are corrupted, isolates the frame to prevent the frame from being ingested by a neural network of the vehicle.

2. The vehicular driving assist system of claim 1, wherein processing by the image processor of the one or more frames of image data captured by the camera further comprises performing at least one selected from the group consisting of (i) demosaicing of the one or more frames of image data, (ii) noise reduction of the one or more frames of image data and (iii) color correction of the one or more frames of image data.

3. The vehicular driving assist system of claim 1, wherein the cryptographic hash function is at least one selected from the group consisting of (i) SHA-256, (ii) BLAKE2s and (iii) Advanced Encryption Standard (AES).

4. The vehicular driving assist system of claim 1, wherein the respective hash values for each scanned line of the two or more scanned lines of the frame are aggregated via at least one selected from the group consisting of (i) a Merkle tree and (ii) a tree of hash chains.

5. The vehicular driving assist system of claim 1, wherein the ECU scans two or more lines of a second frame of image data, and wherein the vehicular driving assist system determines a respective hash value for each scanned line of the two or more scanned lines of the second frame, and wherein the vehicular driving assist system aggregates the respective hash values for each scanned line of the two or more scanned lines of the second frame into a second final frame hash value, and wherein the vehicular driving assist system determines that the second final frame hash value indicates that the two or more scanned lines of the second frame are uncorrupted, and wherein the vehicular driving assist system, responsive to determining that the two or more scanned lines of the second frame are uncorrupted, outputs the second frame to the neural network of the vehicle.

6. The vehicular driving assist system of claim 5, wherein the second final frame hash value is transmitted with the second frame of image data to at least one selected from the group consisting of (i) a vehicular control system, (ii) a lane-keep system, (iii) an obstacle avoidance system, (iv) an auto park assistance system, (v) a blind spot monitoring system, (vi) an adaptive cruise control system, (vii) a lane-centering control system and (viii) a lane-change assist system.

7. The vehicular driving assist system of claim 1, wherein the final frame hash value is stored in secure memory of the vehicular driving assist system.

8. The vehicular driving assist system of claim 1, wherein the vehicular driving assist system, responsive to isolating the frame, stores the final frame hash value as a diagnostic message in memory of the vehicular driving assist system.

9. The vehicular driving assist system of claim 1, wherein the vehicular driving assist system, responsive to determining that the final frame hash value indicates that at least one line of the two or more scanned lines of the frame are corrupted, notifies a driver of the vehicle of the determined corrupt frame of image data.

10. The vehicular driving assist system of claim 1, wherein the vehicular driving assist system, responsive to determining that the final frame hash value indicates that at least one line of the two or more scanned lines of the frame are corrupted, disables the camera.

11. The vehicular driving assist system of claim 1, wherein the vehicular driving assist system disables, responsive to determining that the final frame hash value indicates that at least one line of the two or more scanned lines of the frame are corrupted, a system of the vehicle that receives as input processed image data from the camera.

12. A method for processing image data in a vehicular driving assist system, the method comprising:
capturing, via a camera disposed at a vehicle equipped with the vehicular driving assist system and viewing an exterior of the vehicle, image data, wherein the camera comprises an imager;
scanning, via an electronic control unit (ECU) comprising an image processor for processing the image data, two or more lines of a frame of the image data;
determining, via a cryptographic hash function, a respective hash value for each scanned line of the two or more scanned lines of the frame;
aggregating, responsive to determining the respective hash value for each scanned line of the two or more scanned lines of the frame, the respective hash values for each line of the two or more lines of the frame into a final frame hash value;
determining, responsive to aggregating the respective hash values for each line of the two or more lines of the frame into the final frame hash value, that the final frame hash value indicates that at least one line of the two or more scanned lines of the frame is corrupted; and
isolating, responsive to determining that the final frame hash value indicates that at least one line of the two or more scanned lines of the frame is corrupted, the frame to prevent the frame from being ingested by a neural network of the vehicle.

13. The method of claim 12, further comprising processing, via the image processor, the frame of the image data, wherein processing comprises performing at least one selected from the group consisting of (i) demosaicing of the frame of the image data, (ii) noise reduction of the frame of the image data, and (iii) color correction of the frame of the image data.

14. The method of claim 12, wherein the cryptographic hash function is at least one selected from the group consisting of (i) SHA-256, (ii) BLAKE2s, and (iii) Advanced Encryption Standard (AES).

15. The method of claim 12, wherein aggregating the respective hash values for each scanned line of the two or more scanned lines of the frame comprises aggregating the respective hash values via at least one selected from the group consisting of (i) a Merkle tree and (ii) a tree of hash chains.

16. The method of claim 12, further comprising:
scanning, via the ECU, two or more lines of a second frame of image data;
determining a respective hash value for each scanned line of the two or more scanned lines of the second frame;
aggregating the respective hash values for each scanned line of the two or more scanned lines of the second frame into a second final frame hash value;
determining that the second final frame hash value indicates that the two or more scanned lines of the second frame are uncorrupted; and
responsive to determining that the two or more scanned lines of the second frame are uncorrupted, outputting the second frame to the neural network of the vehicle.

17. The method of claim 16, further comprising transmitting the second final frame hash value with the second frame of image data to at least one selected from the group consisting of (i) a vehicular control system, (ii) a lane-keep system, (iii) an obstacle avoidance system, (iv) an auto park assistance system, (v) a blind spot monitoring system, (vi) an adaptive cruise control system, (vii) a lane-centering control system, and (viii) a lane-change assist system.

18. The method of claim 12, further comprising storing the final frame hash value in secure memory of the vehicular driving assist system.

19. The method of claim 12, further comprising storing, responsive to isolating the frame, the final frame hash value as a diagnostic message in memory of the vehicular driving assist system.

20. The method of claim 12, further comprising notifying, responsive to determining that the final frame hash value indicates that at least one line of the two or more scanned lines of the frame is corrupted, a driver of the vehicle of the determined corrupt frame of image data.
